(19) United States
(12) Patent Application Publication
(10) Pub. No.: US 2025/0174809 A1
(43) Pub. Date: May 29, 2025

(54) BATTERY PACK AND BATTERY ASSEMBLY

(71) Applicant: HONDA MOTOR CO., LTD., Tokyo (JP)

(72) Inventors: Daigo KOMATSU, Tokyo (JP); Keiji TAKEUCHI, Tokyo (JP)

(73) Assignee: HONDA MOTOR CO., LTD., Tokyo (JP)

(21) Appl. No.: 18/953,099

(22) Filed: Nov. 20, 2024

(30) Foreign Application Priority Data
Nov. 24, 2023 (JP) 2023-199088

(51) Int. Cl. H01M 50/317; H01M 50/209; H01M 50/358

(52) U.S. Cl. CPC H01M 50/317; H01M 50/209; H01M 50/358

(57) ABSTRACT

A battery pack has a cell laminate which has a plurality of laminated battery cells each including a safety valve, an exhaust duct which connects the safety valves of the battery cells and extends in a lamination direction of the battery cells, and a case which accommodates the cell laminate and the exhaust duct. The case is provided with a pressure relief valve which communicates with the exhaust duct and an open space outside the case and is configured to exhaust gas discharged from the safety valve of the battery cell to the open space, and a check valve which communicates with a sealed space outside the case and is configured to exhaust the gas to the sealed space.

### CROSS-REFERENCE TO RELATED APPLICATIONS

This application is based on and claims priority under 35 USC 119 from Japanese Patent Application No. 2023-199088 filed on Nov. 24, 2023, the entire content of which is incorporated herein by reference.

### TECHNICAL FIELD

The present disclosure relates to a battery pack including a cell laminate having a plurality of laminated battery cells, and a battery assembly.

### BACKGROUND ART

In recent years, researches and developments have been conducted on a secondary battery which contributes to improvement in energy efficiency in order to allow more people to have access to affordable, reliable, sustainable and advanced energy.

As a drive source of a vehicle is electrified, a battery that supplies power to a motor or the like is mounted on the vehicle. The battery is configured by laminating a plurality of battery cells, for example. Each battery cell is provided with a valve for discharging high-temperature and high-pressure gas generated inside out of the battery cell (for example, JP2003-178740A and JP5939307B2).

In addition, JP5939307B2 describes a gas discharge structure for battery module, including: a cell unit obtained by laminating a plurality of cells each including an explosion-proof valve; a module case accommodating the cell unit; an internal pressure release portion that penetrates the module case and discharges gas accumulated therein to the outside; and a partition wall disposed between the cell unit and the internal pressure release portion.

In JP5939307B2, although the case is provided with the internal pressure release portion, the inside of the case is temporarily pressurized when gas is discharged into the case from the explosion-proof valve of the cell due to thermal runaway. In order to reduce an influence on the outside due to the pressure rise in the case, there is a demand for a configuration capable of appropriately relaxing the pressure rise in the case.

### SUMMARY OF INVENTION

The present disclosure provides a battery pack and a battery assembly that enable to relax a pressure rise in a case at the time of thermal runaway of battery cells. This further contributes to improvement in energy efficiency.

A first aspect of the present disclosure relates to a battery pack having:
a cell laminate having a plurality of laminated battery cells each including a safety valve;
an exhaust duct connecting the safety valves of the battery cells and extending in a lamination direction of the battery cells; and
a case accommodating the cell laminate and the exhaust duct,
in which the case is provided with:
   a pressure relief valve communicating with the exhaust duct and an open space outside the case and configured to exhaust gas discharged from the safety valve of the battery cell to the open space; and
   a check valve communicating with a sealed space outside the case and configured to exhaust the gas to the sealed space.

A second aspect of the present disclosure relates to a battery assembly having:
a plurality of battery packs; and
a conductive member accommodating portion connecting the plurality of battery packs in a liquid-tight manner and having a first conductive member disposed therein, the first conductive member electrically connecting the plurality of battery packs,
in which each of the battery packs includes:
   a cell laminate having a plurality of laminated battery cells each including a safety valve;
   an exhaust duct connecting the safety valves of the battery cells and extending in a lamination direction of the battery cells; and
   a case accommodating the cell laminate and the exhaust duct and connected to the conductive member accommodating portion, and
the case is provided with:
   a pressure relief valve communicating with the exhaust duct and an open space outside the case and configured to exhaust gas discharged from the safety valve of the battery cell to the open space; and
   a check valve communicating with the conductive member accommodating portion and configured to exhaust the gas to the conductive member accommodating portion.

According to the aspects of the present disclosure, it is possible to relax a pressure rise in a case at the time of thermal runaway of battery cells.

### BRIEF DESCRIPTION OF DRAWINGS

Exemplary embodiment(s) of the present invention will be described in detail based on the following figures, wherein:

FIG. 1 is an external perspective view of a battery pack 10;

FIG. 2 is an exploded perspective view of the battery pack 10;

FIG. 3 is an exploded perspective view of a cell laminate 30;

FIG. 4 is an external perspective view of a battery assembly 100;

FIG. 5 is an external perspective view of the battery assembly 100 when viewed from the bottom surface, with a bottom cover 126 being disassembled;

FIG. 6 is an external perspective view of a central frame 120;

FIG. 7 is an external perspective view of an expanded portion 22;

FIG. 8 is a cross-sectional view taken along a line A-A of FIG. 7;

FIG. 9 is a view illustrating a state in which gas generated during thermal runaway of battery cells 40 is exhausted out of a cell accommodation space 25 through an insertion port 93; and

FIG. 10 is a view illustrating the flow of gas in the battery assembly 100 when thermal runaway occurs in a certain battery pack 10.

### DESCRIPTION OF EMBODIMENTS

Hereinafter, an embodiment of a battery pack of the present disclosure will be described with reference to the accompanying drawings. In the following description, for convenience, a coordinate system including a front-rear direction, a left-right direction, and an upper-lower direction orthogonal to each other is used. In the drawings, the front side is denoted by Fr, the rear side is denoted by Rr, the left side is denoted by L, the right side is denoted by R, the upper side is denoted by U, and the lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

### [Battery Pack]

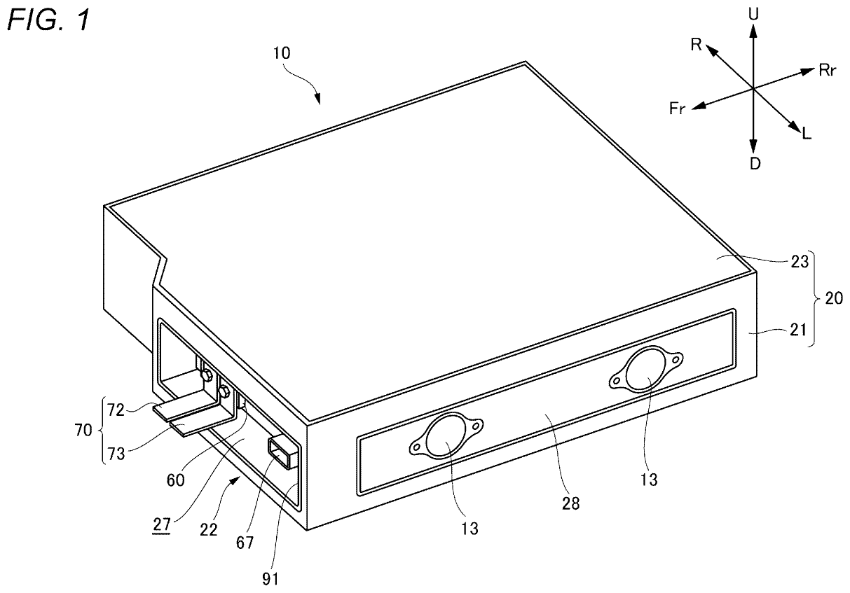

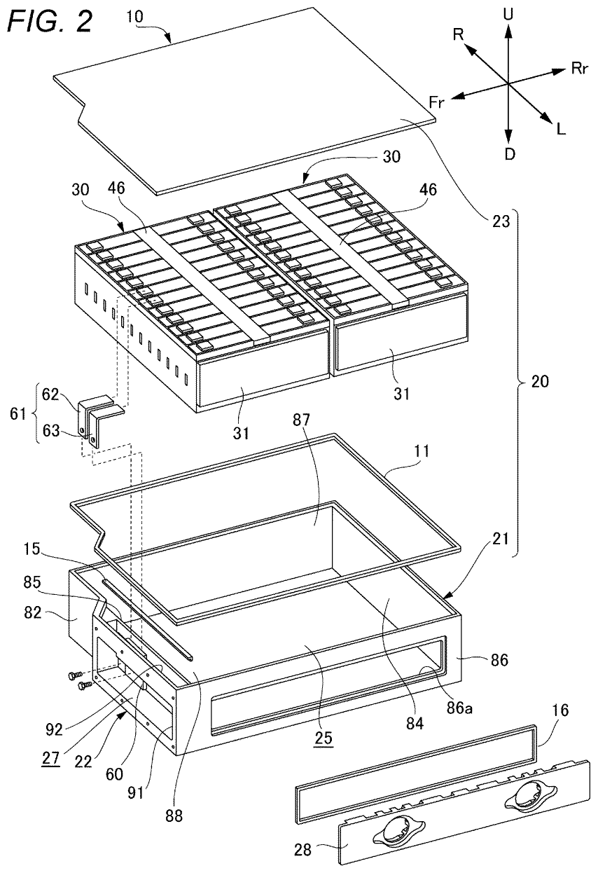

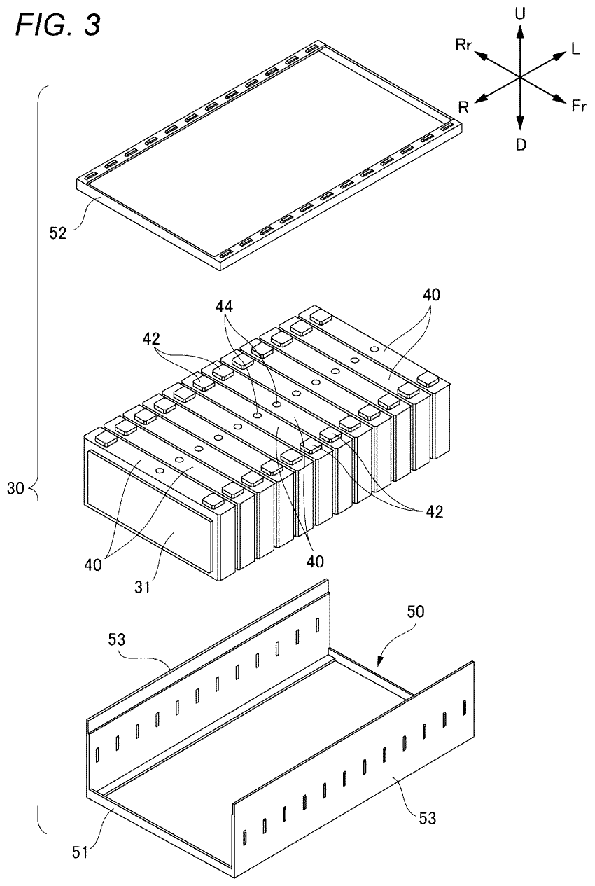

In a battery pack 10, as illustrated in FIGS. 1 and 2, two cell laminates 30 are aligned in the front-rear direction inside a box-shaped case 20. As illustrated in FIG. 3, each cell laminate 30 has a plurality of square battery cells 40 laminated in the left-right direction, and an end plate 31 disposed on one side in the left-right direction (the left side in the present embodiment), which are temporarily fixed at a predetermined pressure by using a binder 50. A separator (not illustrated) may be disposed between adjacent battery cells 40. The binder 50 includes a rectangular lower restraint portion 51 surrounding the bottom surface of the cell laminate 30, a rectangular upper restraint portion 52 surrounding the upper surface of the cell laminate 30, and a pair of side restraint portions 53 sandwiching the cell laminate 30 in the front-rear direction. The lower restraint portion 51 and the pair of side restraint portions 53 are formed integrally. The other side in the left-right direction (the right side in the present embodiment) of the cell laminate 30 may be provided with another end plate, a separator, or the like, so that the battery cells 40 are not in direct contact with the case 20 on the other side. The cell laminate 30 may not be configured such that the plurality of battery cells 40 are restrained by the binder 50. That is, the plurality of battery cells 40 may be directly laminated inside the case 20.

The battery cells 40 are each, for example, a secondary battery such as a lithium ion battery. The upper surface of each battery cell 40 is provided with a pair of terminals 42 provided at both ends in the front-rear direction, which is a direction orthogonal to the lamination direction of the battery cells 40, and a safety valve 44 provided at the central portion in the front-rear direction and arranged between the pair of terminals 42. The pair of terminals 42 include a positive terminal and a negative terminal. For example, the positive terminal is connected to the negative terminal of an adjacent battery cell 40 via a bus bar (not illustrated), and the negative terminal is connected to the positive terminal of an adjacent battery cell 40 via a bus bar (not illustrated), whereby the plurality of battery cells 40 are electrically connected in series. For example, in order to shorten the length of the bus bar, the plurality of battery cells 40 may be laminated such that the orientations thereof in the front-rear direction are reversed alternately.

The safety valve 44 is a rupture valve, and prevents rupture of the outer can when the internal pressure of the battery cell 40 abnormally rises. If the internal pressure of the battery cell 40 abnormally rises, the safety valve 44 ruptures and the gas in the battery cell 40 is discharged to the outside. By providing the safety valve 44 in the central portion of the battery cell 40 in the front-rear direction, the plurality of battery cells 40 can be aggregated at the same position in the front-rear direction even if laminated such that the orientations thereof in the front-rear direction are reversed alternately.

The battery cells 40 are provided with an exhaust duct 46 that connects the safety valves 44 of the plurality of battery cells 40 and that allows the gas discharged from the safety valves 44 to flow. For example, the exhaust duct 46 is configured with a hood that covers the safety valves 44. The exhaust duct 46 extends in the direction in which the safety valves 44 are aligned, that is, in the lamination direction of the battery cells 40, and guides the gas toward a pressure relief valve 13 to be described later.

Returning to FIG. 2, the case 20 includes a case body 21 whose upper side is open, and a case cover 23 that covers the opening of the case body 21. The case body 21 includes a front wall 82 and a rear wall 84 that extend in the left-right direction, a left wall 86 that connects the left ends of the front wall 82 and the rear wall 84, a right wall 87 that connects the right ends of the front wall 82 and the rear wall 84, and a bottom wall 88. A space surrounded by the front wall 82, the rear wall 84, the left wall 86, and the right wall 87 constitutes a cell accommodation space 25 for accommodating the cell laminates 30.

The left wall 86 is provided with an opening 86a that allows the cell accommodation space 25 to communicate with the outside, and is attached with a pressurization plate 28 via a seal member 16 (for example, a rubber seal). By fixing the pressurization plate 28 to the left wall 86, the pressurization plate 28 comes into contact with the end plate 31 of each cell laminate 30 from the opening 86a. When the pressurization plate 28 presses the end plate 31 inward, the cell laminate 30 temporarily fixed to the binder 50 at a predetermined pressure is further pressurized in the lamination direction and held in the case 20. The pressurization plate 28 may be fixed to the left wall 86 by welding such as friction stir welding, or may be fixed by bolts. According to such battery pack 10, the plurality of battery cells 40 can be held in the case 20 without being modularized, thereby improving the energy density and the space efficiency.

As illustrated in FIG. 1, the pressurization plate 28 is provided with two pressure relief valves 13 communicating with the cell accommodation space 25. When the internal pressure of the cell accommodation space 25 abnormally rises due to the gas generated from the safety valve 44 of the battery cell 40, the pressure relief valves 13 are opened to discharge the gas in the case 20 to the outside.

An expanded portion 22 is formed forward of and leftward of the front wall 82 in a manner protruding further forward of the front wall 82. The expanded portion 22 has a space formed inside, and has a first opening 91 provided in the front surface and a second opening 92 provided in the upper surface. The internal space of the expanded portion 22 is provided with a terminal block 60 connected with a lead-out conductive member 70, and forms an output terminal accommodation space 27. Electrically connected in the terminal block 60 are a terminal (output terminal) of an output conductive member 61 extending from the cell accommodation space 25 to the output terminal accommodation space 27, and a terminal of the lead-out conductive member 70 entering the output terminal accommodation space 27 from the first opening 91. The output conductive member 61 includes a positive-side bus bar 62 and a negative-side bus bar 63 respectively extending from the positive-side output terminal and the negative-side output terminal of the two cell laminates 30 electrically connected in series. The lead-out conductive member 70 includes, for example, a positive-side bus bar 72 and a negative-side bus bar 73 respectively connected to external positive terminal and negative terminal.

As described above, the case 20 is provided with the cell accommodation space 25 that accommodates the two cell laminates 30, and the output terminal accommodation space 27 arranged forward of and leftward of the cell accommodation space 25 and connected with the lead-out conductive member 70. The number of the cell laminates 30 accommodated in the cell accommodation space 25 may be one or three or more.

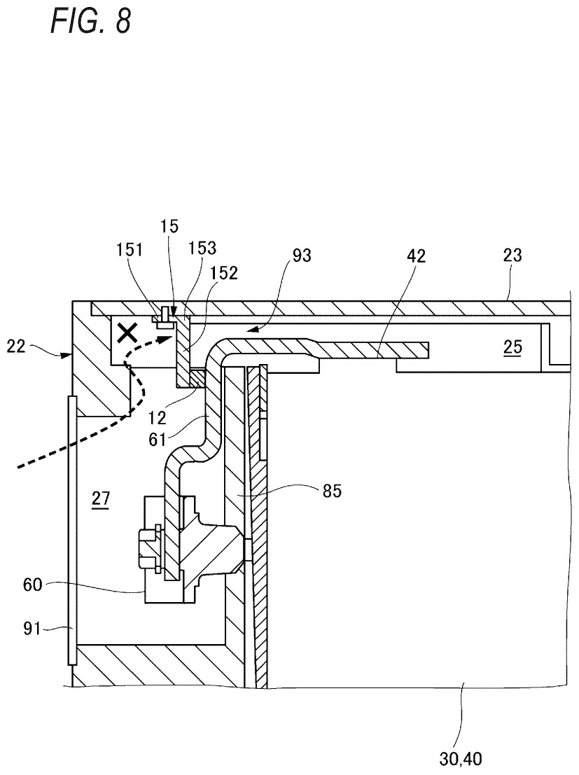

A region of the front wall 82 that separates the cell accommodation space 25 from the output terminal accommodation space 27 (hereinafter, this portion is referred to as a partition wall 85) is lower in height than the other regions. A gap is provided between the upper end of the partition wall 85 and the case cover 23. The gap serves as an insertion port 93 having the output conductive member 61 inserted therein (see FIG. 8). A one-end side of the output conductive member 61 extends forward from the insertion port 93 to the output terminal accommodation space 27, and an other-end side extends downward and is fixed to the terminal block 60 provided in the output terminal accommodation space 27.

As illustrated in FIG. 1, the output terminal accommodation space 27 is provided with a signal line connector 67. The signal line connector 67 is connected with a signal line via a through hole that allows the cell accommodation space 25 to communicate with the output terminal accommodation space 27.

The upper surface of the case body 21 is attached with a case cover 23 via a first seal member 11 (for example, a rubber seal). The case cover 23 is fixed to the upper surface of the case body 21 by welding such as friction stir welding, for example. By sealing the cell accommodation space 25 from the outside, it is possible to limit intrusion of foreign matters into the cell accommodation space 25, thereby limiting deterioration of the battery cells 40.

The battery pack 10 configured as described above does not include an auxiliary device such as an ECU or a junction box that accommodates a comparator, a fuse, and the like. Therefore, if the battery pack 10 is used alone, the battery pack 10 may be connected to a junction box and/or an ECU. If a plurality of battery packs 10 are used, the battery packs 10 may be electrically connected to each other in a connection box, and the connection box may be connected to a junction box and/or an ECU. Further, a junction box and/or an ECU may be incorporated in a connection box, and the plurality of battery packs 10, the junction box and/or the ECU may be connected in the connection box.

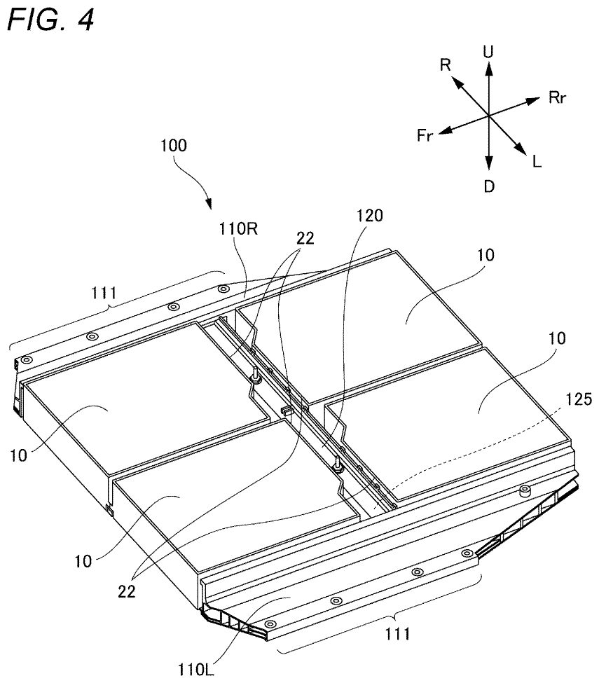

Next, a mounting structure for battery pack for mounting four battery packs 10 under the floor of a vehicle will be described with reference to FIGS. 4 to 6. In the following description, the front-rear direction, the left-right direction (vehicle width direction), and the upper-lower direction are defined with reference to the vehicle.

In this mounting structure, as illustrated in FIG. 4, a central frame 120 extending in the vehicle width direction is fixed between a left side frame 110L and a right side frame 110R extending in the front-rear direction of the vehicle. Two of the battery packs 10 are aligned in the left-right direction in a space forward of the central frame 120, and two of the battery packs 10 are aligned in the left-right direction in a space behind the central frame 120. The four battery packs 10 are fixed to and supported by the left side frame 110L, the right side frame 110R, and the central frame 120. Hereinafter, this structure will be referred to as a battery assembly 100.

### [Battery Assembly]

In the battery assembly 100, the two front battery packs 10 are arranged such that the expanded portion 22 is positioned on the rear and the right, and the two rear battery packs 10 are arranged such that the expanded portion 22 is positioned on the front and the left. That is, the two front battery packs 10 on the and the two rear battery packs 10 are arranged in a state of being rotated by 180° such that the expanded portions 22 face each other in the front-rear direction with the central frame 120 interposed therebetween.

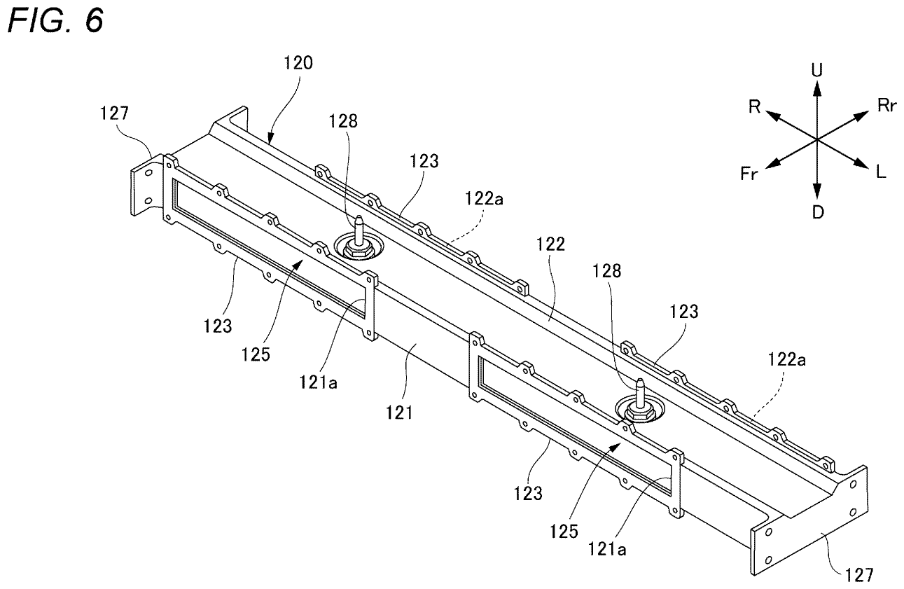

As illustrated in FIG. 6, the central frame 120 of the battery assembly 100 is a hollow body having a rectangular cross section, and is fastened to the left side frame 110L and the right side frame 110R by flanges 127 formed at the left and right ends and extending in the front-rear direction.

A front surface 121 of the central frame 120 is formed with two front communication holes 121a, which respectively communicate with the first openings 91 formed in the expanded portions 22 of the front battery packs 10. Similarly, a rear surface 122 of the central frame 120 is formed with two rear communication holes 122a, which respectively communicate with the first openings 91 formed in the expanded portions 22 of the rear battery packs 10. The front communication hole 121a and the rear communication hole 122a are offset in the vehicle width direction. That is, the central position of the front communication hole 121a in the vehicle width direction and the central position of the rear communication hole 122a in the vehicle width direction are offset in the vehicle width direction.

Fastening portions 123 for fastening the corresponding battery packs 10 in a liquid-tight manner are provided around the front communication hole 121a and the rear communication hole 122a. Each battery pack 10 is fixed to the central frame 120 by, for example, bolt fastening. The central frame 120 has the fastening portions 123 on the front surface 121 and the rear surface 122, respectively, and the front surface 121 and the rear surface 122 protrude vertically, thereby forming a high-rigidity cross-sectional shape like H steel in a cross section cut in the front-rear direction.

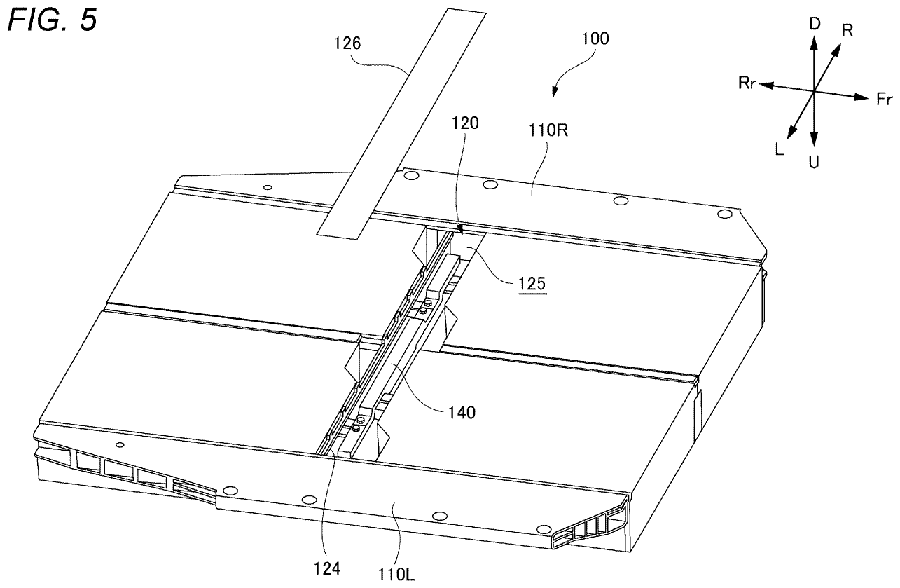

From the output terminal accommodation space 27 formed in the expanded portion 22 of each battery pack 10, the lead-out conductive member 70 enters a hollow region 125 of the central frame 120 through the first opening 91. As illustrated in FIG. 5, the bus bar unit 140 is arranged in the hollow region 125 of the central frame 120. The bus bar unit 140 includes, for example, a plurality of connection bus bars, and electrically connects the four battery packs 10 in series, for example. The central frame 120 is an example of the above-described connection box. The hollow region 125 of the central frame 120 corresponds to the “sealed space” and the “conductive member accommodating portion” of the present disclosure.

The back surface of the central frame 120 is provided with a bottom opening 124. The bottom opening 124 is closed in a liquid-tight manner by the bottom cover 126 via a sealing member (not illustrated). The bottom opening 124 of the central frame 120 is closed by the bottom cover 126 in a liquid-tight manner, and the communication holes 121a and 122a of the central frame 120 and the first openings 91 of the battery packs 10 are fastened in a liquid-tight manner. This restricts the entry of water from the outside into the output terminal accommodation space 27 of the battery pack 10 and the hollow region 125 of the central frame 120. The lead-out conductive member 70 extending from each battery pack 10 to the hollow region 125 of the central frame 120 is fastened to the bus bar unit 140 from the bottom opening 124 with the bottom cover 126 detached.

The battery assembly 100 configured as described above is fixed to the frame member of the vehicle by a pair of central supports 128 provided on the central frame 120, and side supports 111 provided on the left side frame 110L and the right side frame 110R, and is arranged under the floor of the vehicle.

### [Gas Exhaust Structure]

Some abnormality occurring in the battery cells 40, for example, an internal short circuit, may generate thermal runaway, i.e. abnormal heat generation, in the battery cells 40, and generate high-temperature and high-pressure gas inside the battery cells 40. When the pressure of the gas generated inside the battery cells 40 rises to a predetermined value or more, the safety valve 44 ruptures, and the gas is discharged out of the battery cells 40, that is, into the case 20.

The battery pack 10 is provided with the above-described pressure relief valve 13 to exhaust gas filling the inside of the case 20 out of the case 20 during thermal runaway. However, since the cell laminate 30 is densely arranged in the case 20 while being pressurized by the pressurization plate 28, the gap between the cell laminate 30 and the case 20 is small, and the inside of the case 20 tends to have a high pressure when discharging the gas from the safety valves 44. Therefore, it is preferable to further provide the battery pack 10 with a configuration for relaxing the pressure rise in the case 20 in addition to the pressure relief valve 13.

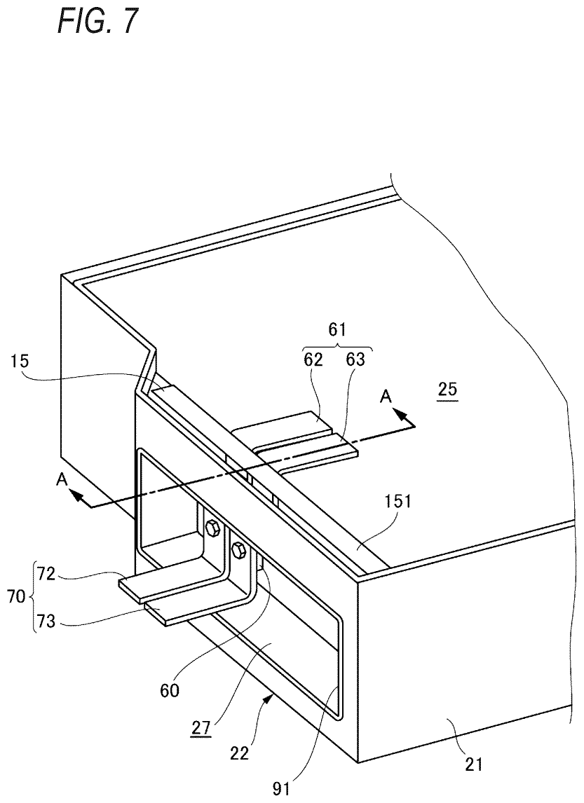

In the present embodiment, the battery pack 10 further includes a check valve 15 as illustrated in FIGS. 7 to 9. The check valve 15 communicates with the hollow region 125 of the central frame 120 outside the case 20, and is configured to exhaust gas filling the cell accommodation space 25 into the hollow region 125.

When the pressure of the cell accommodation space 25 rises due to thermal runaway of the battery cells 40, the pressure relief valve 13 is opened to exhaust the gas filling the cell accommodation space 25 to the open space outside the case 20 and release the pressure of the cell accommodation space 25. Furthermore, since the check valve 15 is also opened to exhaust the gas to the hollow region 125 of the central frame 120, which is a sealed space, and to relax the pressure rise in the cell accommodation space 25 at the initial stage of thermal runaway of the battery cells 40. As described above, during thermal runaway of the battery cells 40, the battery pack 10 is opened at two locations, the pressure relief valve 13 and the check valve 15, thereby appropriately releasing the pressure and relaxing the pressure rise inside the case 20. This can relax the impact at the time of thermal runaway, and limit the influence on the outside due to the pressure rise of the case 20.

In addition, since the hollow region 125 is a sealed space, the flow of the gas toward the hollow region 125 settles down after a constant amount of gas flows into the hollow region 125 (that is, after the initial stage of thermal runaway). After the initial stage of thermal runaway, substances such as the electrolytes or the electrodes of the battery cells 40 (hereinafter also referred to as cell contents) can be discharged from the safety valve 44. Since the flow of the gas toward the hollow region 125 settles down, the cell contents are guided toward the pressure relief valve 13 and discharged out of the case 20 without flowing to the hollow region 125. This can limit the occurrence of a short circuit in the bus bar unit 140 of the hollow region 125 due to the cell contents.

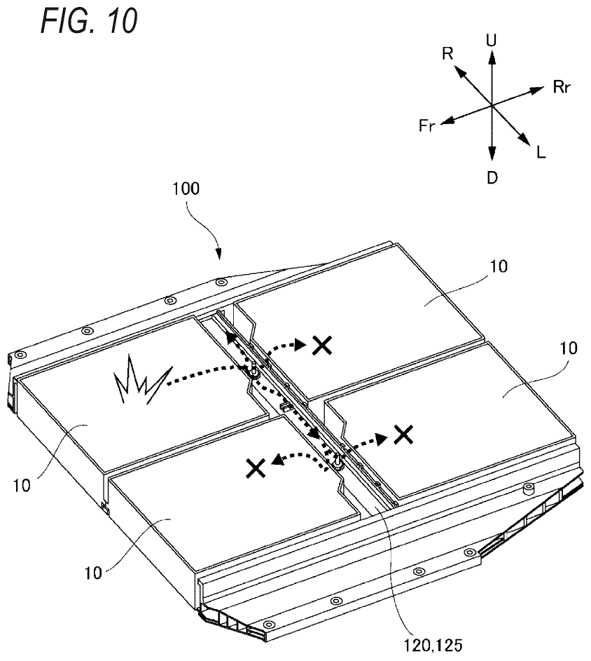

Further, since the check valve 15 has the function of restricting the flow of the gas from the outside of the case 20, as illustrated in FIG. 10, for example, even if thermal runaway occurs in the battery pack 10 arranged on the front and the right in the battery assembly 100 and gas is discharged from the battery pack 10 to the hollow region 125 of the central frame 120, the gas does not flow into the other three battery packs 10 due to the check valve 15. Therefore, it is possible to prevent thermal runaway generated in a certain battery pack 10 from causing chain thermal runaway in the other battery packs 10.

An example of a specific configuration of the check valve 15 will be described below. The configuration of the check valve 15 is not limited to this example, and various configurations can be adopted.

As illustrated in FIG. 8, the check valve 15 of the present embodiment is provided in the case 20 in a manner covering the insertion port 93 having the output conductive member 61 inserted therein. The check valve 15 is provided outside the cell accommodation space 25, specifically, in the output terminal accommodation space 27, and covers the insertion port 93 from the side closer to the output terminal accommodation space 27. The insertion port 93 and the check valve 15 extend in the left-right direction along the partition wall 85.

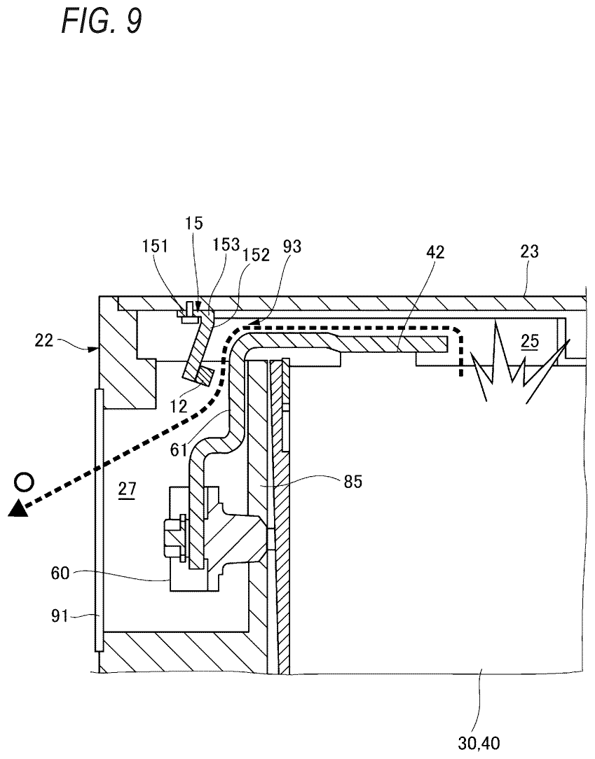

The check valve 15 normally covers a part of the insertion port 93 and the output conductive member 61 via a seal member 12 (for example, a foamed seal) and seals the cell accommodation space 25 together with the case cover 23. On the other hand, as illustrated in FIG. 9, when the pressure of the cell accommodation space 25 rises due to thermal runaway of the battery cells 40, the check valve 15 opens to exhaust the gas from the insertion port 93 into the hollow region 125 of the central frame 120 and release the pressure in the cell accommodation space 25.

More specifically, the check valve 15 is a substantially L-shaped plate member. A one-end side 151 of the check valve 15 extends in the horizontal direction and is fixed to the lower surface of the case cover 23 located outside the cell accommodation space 25. The one-end side 151 may be fixed to the case cover 23 by, for example, a fastening member such as a bolt, or may be fixed by welding such as friction stir welding.

An other-end side 152 of the check valve 15 extends in the upper-lower direction and covers the insertion port 93 via the seal member 12. The other-end side 152 is provided in close contact with the partition wall 85 and the output conductive member 61 via the seal member 12. In this way, the check valve 15 covers the insertion port 93 having the output conductive member 61 inserted therein together with the seal member 12, thereby ensuring the sealing property of the cell accommodation space 25. This can also prevent foreign matters from entering the cell accommodation space 25 through the insertion port 93.

As illustrated in FIG. 9, the check valve 15 is deformed to open the insertion port 93 when the gas is filled in the cell accommodation space 25 due to thermal runaway of the battery cells 40 and the pressure in the cell accommodation space 25 rises. The check valve 15 has a bent portion 153 between the one-end side 151 and the other-end side 152, and rotates around the bent portion 153 by the pressure of the gas to exhaust the gas to the hollow region 125 of the central frame 120. In other words, the check valve 15 is configured as a flap whose one-end side 151 is fixed and whose other-end side 152 rotates around the bent portion 153.

As described above, the check valve 15 can exhaust the gas to the hollow region 125 of the central frame 120 to release the pressure when the pressure in the cell accommodation space 25 rises, while covering the insertion port 93 having the output conductive member 61 inserted therein to ensure the sealing property of the cell accommodation space 25. Further, the check valve 15 is a substantially L-shaped plate member, and can be deformed, that is, can rotate around the bent portion 153 relatively easily, and thus can release the pressure in the cell accommodation space 25 without rupturing the case body 21 or the case cover 23.

The pressure relief valve 13 is provided at a position in the lamination direction relative to the cell laminate 30, specifically, on the left wall 86, whereas the check valve 15 is provided at a position in a direction orthogonal to the lamination direction relative to the cell laminate 30, specifically, on the front. That is, the pressure relief valve 13 and the check valve 15 are provided in different directions when viewed from the cell laminate 30. Therefore, the cell contents can be limited from flowing toward the check valve 15 when guided toward the pressure relief valve 13 along the lamination direction.

In addition, since the pair of terminals 42 of each battery cell 40 are provided at both ends in a direction orthogonal to the lamination direction (that is, front portion and rear portion) with the safety valve 44 interposed therebetween, the cell contents can be prevented from adhering to the terminals 42 and causing a short circuit when the cell contents are guided toward the pressure relief valve 13 along the lamination direction.

In addition, since the check valve 15 is provided in a direction orthogonal to the lamination direction relative to the cell laminate 30, the cell contents can be prevented from adhering to the output conductive member 61 and the lead-out conductive member 70 provided in the vicinity of the check valve 15 and causing a short circuit when the cell contents are guided toward the pressure relief valve 13 along the lamination direction.

Further, since the insertion port 93 and the check valve 15 extend in the left-right direction, it is possible to provide a wide exhaust port when exhausting the gas to the hollow region 125. Thus, the pressure in the cell accommodation space 25 can be released sufficiently.

Although an embodiment of the present disclosure has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

For example, in the above-described embodiment, the battery assembly 100 is constituted by four battery packs 10 in total on the front, rear, left, and right, but is not limited thereto. A configuration of two battery packs 10 in total, respectively on the front and the rear, is also possible. Two or more battery packs 10 may be arranged on the front and the rear and/or on the left and the right.

In the above-described embodiment, the check valve 15 communicates with the hollow region 125 of the central frame 120 in which the bus bar unit 140 is disposed, but is not limited thereto. For example, the check valve 15 may communicate with a sealed space in which an electrical device other than the bus bar unit 140 is disposed. For example, if the battery packs 10 are used alone instead of the battery assembly 100, a box or a tank constituting a sealed space may be provided to communicate with the first opening 91, and the check valve 15 may communicate with the sealed space.

In the present specification, at least the following matters are described. In the parentheses, the corresponding constituent elements and the like in the above embodiment are shown as an example, but the present invention is not limited thereto.

(1) A battery pack (battery pack 10) including:
a cell laminate (cell laminate 30) having a plurality of laminated battery cells (battery cells 40) each including a safety valve (safety valve 44);
an exhaust duct (exhaust duct 46) connecting the safety valves of the battery cells and extending in a lamination direction of the battery cells; and
a case (case 20) accommodating the cell laminate and the exhaust duct,
in which the case is provided with:
   a pressure relief valve (pressure relief valve 13) communicating with the exhaust duct and an open space outside the case and configured to exhaust gas discharged from the safety valve of the battery cell to the open space, and
   a check valve (check valve 15) communicating with a sealed space (hollow region 125) outside the case and configured to exhaust the gas to the sealed space.

According to (1), since the case is provided with the check valve communicating with the sealed space, when high-pressure gas is generated from the safety valves of the battery cells due to thermal runaway, the check valve can be opened to release the pressure in the case in the initial stage of the thermal runaway, thereby relaxing the pressure rise in the case. The flow of the gas toward the check valve settles down after the gas flows into the sealed space, so that it is possible to discharge the gas and the cell contents that may be generated together with the gas out of the case from the pressure relief valve communicating with the open space.

(2) The battery pack according to (1),
in which the pressure relief valve is provided at a position in the lamination direction relative to the cell laminate, and
the check valve is provided at a position in a direction orthogonal to the lamination direction relative to the cell laminate.

According to (2), the cell contents that may be discharged from the safety valve of the battery cell due to thermal runaway or the like can be limited from flowing toward the check valve when guided toward the pressure relief valve.

(3) The battery pack according to (2),
in which the sealed space is a conductive member accommodating portion (hollow region 125) in which a first conductive member (bus bar unit 140) configured to electrically connect the battery pack and another battery pack is disposed.

According to (3), in the initial stage of the thermal runaway, the gas can be exhausted from the check valve to the conductive member accommodating portion serving as the sealed space, thereby releasing the pressure in the case to the conductive member accommodating portion. Further, unlike the pressure relief valve, the check valve is provided in a direction orthogonal to the lamination direction relative to the cell laminate, and thus can further limit the flow of the cell contents toward the conductive member accommodating portion.

(4) The battery pack according to (3),
in which the safety valve of each battery cell is provided at a central portion of the battery cell in a direction orthogonal to the lamination direction, and
each battery cell includes terminals (terminals 42) provided at both ends in a direction orthogonal to the lamination direction.

According to (4), since the terminals of the battery cells are provided at both ends in the direction orthogonal to the lamination direction, the cell contents discharged from the safety valve due to thermal runaway can be prevented from flowing toward the terminals of the battery cells and causing a short circuit when guided toward the pressure relief valve.

(5) The battery pack according to (4), further including:
a second conductive member (output conductive member 61) electrically connecting the terminals and the first conductive member disposed in the conductive member accommodating portion,
in which the check valve is provided in a vicinity of the second conductive member.

According to (5), the cell contents discharged from the safety valve due to thermal runaway are guided toward the pressure relief valve without flowing to the check valve, so that the cell contents can be limited from flowing to the second conductive member, which is provided at a position close to the check valve, and causing a short circuit.

(6) The battery pack according to (5),
in which the case includes:
   a case body (case body 21) including a bottom wall (bottom wall 88) and a vertical wall (partition wall 85) erected from the bottom wall; and
   a case cover (case cover 23) covering the case body from above,
an opening (insertion port 93), through which the second conductive member is inserted from the terminal toward the conductive member accommodating portion, is provided between the vertical wall portion and the case cover, and
the check valve covers the opening via a seal member (seal member 12).

According to (6), the check valve and the seal member cover the opening having the second conductive member inserted therein and seal the case, and can open the opening to release the pressure in the case when thermal runaway of the battery cells occurs.

(7) The battery pack according to any one of (1) to (6),
in which the check valve is a substantially L-shaped plate member that covers an opening (insertion port 93) allowing an inside of the case and the sealed space to communicate with each other, and has a one-end side (one-end side 151) fixed to the case and an other-end side (the other-end side 152) covering the opening via a seal member (seal member 12), and
the other-end side rotates around a bent portion (bent portion 153) provided between the one-end side and the other-end side when the gas is discharged from the safety valve of the battery cell.

According to (7), the check valve and the seal member cover the opening communicating with the sealed space and seal the inside of the case, and can open the opening to release the pressure in the case when thermal runaway of the battery cells occurs.

(8) The battery pack according to any one of (1) to (7),
in which the cell laminate is accommodated in the case while being pressed onto the case in the lamination direction of the plurality of battery cells.

According to (8), even in a battery pack in which a cell laminate is pressed and densely accommodated in a case, it is possible to appropriately limit a pressure rise in the case by the check valve.

(9) A battery assembly (battery assembly 100) including:
a plurality of battery packs (battery packs 10); and
a conductive member accommodating portion (hollow region 125) connecting the plurality of battery packs in a liquid-tight manner and having a conductive member (bus bar unit 140) disposed therein, the conductive member electrically connecting the plurality of battery packs,
in which each of the battery packs includes:
   a cell laminate (cell laminate 30) having a plurality of laminated battery cells (battery cells 40) each including a safety valve (safety valve 44);
   an exhaust duct (exhaust duct 46) connecting the safety valves of the battery cells and extending in a lamination direction of the battery cells; and
   a case (case 20) accommodating the cell laminate and the exhaust duct and connected to the conductive member accommodating portion, and
the case is provided with:
   a pressure relief valve (pressure relief valve 13) communicating with the exhaust duct and an open space outside the case and configured to exhaust gas discharged from the safety valve of the battery cell to the open space; and
   a check valve (check valve 15) communicating with the conductive member accommodating portion and configured to exhaust the gas to the conductive member accommodating portion.

According to (9), since the case is provided with the check valve communicating with the conductive member accommodating portion serving as the sealed space, when high-pressure gas is generated from the safety valves of the battery cells due to thermal runaway, the gas is exhausted to the conductive member accommodating portion by the check valve in the initial stage of the gas generation, thereby relaxing the pressure rise in the case. Further, due to the sealing property of the conductive member accommodating portion, the flow of the gas toward the check valve settles down after the gas flows into the conductive member accommodating portion, so that it is possible to discharge the gas and the cell contents that may be generated together with the gas out of the case from the pressure relief valve communicating with the open space.

What is claimed is:

1. A battery pack comprising:
a cell laminate having a plurality of laminated battery cells each including a safety valve;
an exhaust duct connecting the safety valves of the battery cells and extending in a lamination direction of the battery cells; and
a case accommodating the cell laminate and the exhaust duct,
wherein the case is provided with:
a pressure relief valve communicating with the exhaust duct and an open space outside the case and configured to exhaust gas discharged from the safety valve of the battery cell to the open space; and
a check valve communicating with a sealed space outside the case and configured to exhaust the gas to the sealed space.

2. The battery pack according to claim 1,
wherein the pressure relief valve is provided at a position in the lamination direction relative to the cell laminate, and
the check valve is provided at a position in a direction orthogonal to the lamination direction relative to the cell laminate.

3. The battery pack according to claim 2,
wherein the sealed space is a conductive member accommodating portion in which a first conductive member configured to electrically connect the battery pack and another battery pack is disposed.

4. The battery pack according to claim 3,
wherein the safety valve of each battery cell is provided at a central portion of the battery cell in a direction orthogonal to the lamination direction, and
each battery cell includes terminals provided at both ends in a direction orthogonal to the lamination direction.

5. The battery pack according to claim 4, further comprising:
a second conductive member electrically connecting the terminals and the first conductive member disposed in the conductive member accommodating portion,
wherein the check valve is provided in a vicinity of the second conductive member.

6. The battery pack according to claim 5,
wherein the case includes:
a case body including a bottom wall and a vertical wall erected from the bottom wall; and
a case cover covering the case body from above,
an opening, through which the second conductive member is inserted from the terminal toward the conductive member accommodating portion, is provided between the vertical wall portion and the case cover, and
the check valve covers the opening via a seal member.

7. The battery pack according to claim 1,
wherein the check valve is a substantially L-shaped plate member that covers an opening allowing an inside of the case and the sealed space to communicate with each other, and has a one-end side fixed to the case and an other-end side covering the opening via a seal member, and
the other-end side rotates around a bent portion provided between the one-end side and the other-end side when the gas is discharged from the safety valve of the battery cell.

8. The battery pack according to claim 1,
wherein the cell laminate is accommodated in the case while being pressed onto the case in the lamination direction of the plurality of battery cells.

9. A battery assembly comprising:
a plurality of battery packs; and
a conductive member accommodating portion connecting the plurality of battery packs in a liquid-tight manner and having a first conductive member disposed therein, the first conductive member electrically connecting the plurality of battery packs,
wherein each of the battery packs includes:
a cell laminate having a plurality of laminated battery cells each including a safety valve;
an exhaust duct connecting the safety valves of the battery cells and extending in a lamination direction of the battery cells; and
a case accommodating the cell laminate and the exhaust duct and connected to the conductive member accommodating portion, and
the case is provided with:
a pressure relief valve communicating with the exhaust duct and an open space outside the case and configured to exhaust gas discharged from the safety valve of the battery cell to the open space; and
a check valve communicating with the conductive member accommodating portion and configured to exhaust the gas to the conductive member accommodating portion.
